(19) United States
(12) Patent Application Publication
(10) Pub. No.: US 2024/0408946 A1
(43) Pub. Date: Dec. 12, 2024

(54) Embedded car cover

(71) Applicant: ZHEJIANG SURPASS AUTO PARTS CO.,LTD., Wenzhou City (CN)

(72) Inventors: Shiqi Zheng, Wenzhou City (CN); Dongdong Wang, Wenzhou City (CN); Yien Wang, Wenzhou City (CN); Yi Lin, Wenzhou City (CN); Lei Lin, Wenzhou City (CN)

(21) Appl. No.: 18/349,322

(22) Filed: Jul. 10, 2023

(30) Foreign Application Priority Data
Jun. 6, 2023 (CN) 202310662244.5

(51) Int. Cl. B60J 7/14

(52) U.S. Cl. CPC B60J 7/141

(57) ABSTRACT

The present invention discloses a new embedded support structure, it including a limiting part, a support part and a limiting block, the limiting part is connected to the car itself or the car cover, the limiting block is connected to the car cover, one end of the support part is connected to the limiting block by rotation, the other end of the support part is removably connected to the limiting part. The present invention can support the support part by providing a limiting part and a limiting block, when the car cover is folded up and standing, the car cover is connected to the car body by the support part, which can support the car cover stably.

### TECHNICAL FIELD

This invention is relevant to automotive spare parts, especially a new embedded support structure.

### BACKGROUND TECHNOLOGY

The pick-up truck (also known as a sedan truck) is used for carrying goods. Since the pick-up truck's cargo hopper is open, a cover was invented to prevent the goods inside the cargo hopper from getting wet in the rain and snow, by installing the cover on the pick-up truck's cargo hopper and using the cover to cover the goods inside the hopper to prevent the goods inside the hopper from getting wet in the rain.

Most of the existing rigid car covers are opened by folding, with the last plate of the cover unable to rotate, which is not very convenient for the innermost goods in the process of use, and there are also some rigid car covers where the last plate that can be rotated by about 90°, enabling the whole cover to stand up and then be supported by the support bar, which is similar to the support of the front bonnet of a car, with only one support point for the support bar, which can easily cause personal injury if the connection is unstable or slips off.

### ABOUT THE INVENTION

The purpose of the present invention is to provide a new embedded support structure for conventional support structures, which utilises double point supports to improve the safety of the use of the car cover.

In order to solve the above problems of the existing technology, the technical solution adopted in the invention is as follows:

A new embedded support structure includes a limiting member, a support member and a limiting block, the limiting member is connected to the car body or the car cover, the limiting block is connected to the car cover, one end of the support member is connected to the limiting block, the other end of the support member is removably connected to the limiting member.

By providing the limiting member and the limiting block, the support member can be supported, and when the car cover is folded up and standing, it can be connected to the car body by the support member, which can provide stable support for the car cover.

Further, the limiting member includes a base, a fixing buckle and a support part, the fixing buckle and the support part are both connected to the base, the base is connected to the car body or the car cover, the support member is a support bar, the support bar includes a first support bar head and a second support bar head, the first support bar head is connected to the support part, the second support bar head is connected to the limiting block. The limiting block is connected to the car cover by screws, by setting the limiting block in the slider groove, the limiting block can be slid to the appropriate position as required, then the limiting block is connected to the car cover by screws and can be fixed to any position on the slider groove according to the customer's need. By providing a slider groove on the car cover and connecting the limiting block to the slider groove, the limiting block is able to slide in the slider groove and can be installed in different positions on the slider groove as required.

Further, the car cover includes a large front bar and a plurality of plate bodies, two adjacent plate bodies are connected to each other by an intermediate bar assembly, the large front bar and one of the plate bodies are connected by a rotating shaft structure, the large front bar is connected to a limiting member, the limiting member is at a distance greater than or equal to the width of the intermediate bar assembly from the rotating shaft structure. By providing the rotating shaft structure, when the cover is folded to stand, the rotating shaft structure and the support bar work together to support the car cover at two points, the support bar as one point and the rotating shaft structure as the other point, the two support points are located on either sides of the bottom of the stand up car cover, ensuring the stability.

Further, the rotating shaft structure includes a rotating shaft hook and a rotating shaft post, the rotating shaft post is connected to the large front bar, the rotating shaft hook is connected to the plate body, the rotating shaft hook rotates with the rotating shaft post as its centre. The rotating shaft hook is provided with an end, while the rotating shaft post is provided with a stopper, which is used to limit the end. The rotating shaft structure consists of a rotating shaft hook and a rotating shaft post. The rotating shaft hook rotates around the shaft post and when the hook is rotated to a vertical or slightly greater than vertical angle, the end of the hook meets the stopper and forms an interlocking top with the shaft post. As the plate needs to be stood up, the rotation angle of the plate needs to be limited, by interlocking the rotating shaft hook and the rotating shaft post, the rotation angle of the plate can be controlled to ensure that the plate can be stably stood up and will not fall down easily. The limiting member includes a base, a fixing buckle and a support part, the fixing buckle and the support part are both connected to the base, the base is connected to the car body or the large front bar, the support part is a webbing, it also includes a webbing base, the webbing is connected to the car cover through the webbing base, the webbing is connected to the webbing buckle, the webbing buckle is adapted to the fixing buckle. The webbing can be tightened by inserting the webbing into the fixing buckle, which ties the car cover to the large front bar forming a fixing point, and the car cover will be slightly tilted towards front cab. Furthermore, there is another connection point between the car cover and the car body through the rotating shaft structure, which forms a two-point support through the tension of the webbing and the rotating shaft structure to ensure the stability when the car cover is folded and stood up.

Further, the limiting member is a large front bar sheet metal connected to the large front bar, the large front bar sheet metal is provided with a half waist hole, the large front bar sheet metal is used to support the support bar, the support bar is connected with a plum nut. The support bar includes a first support bar head and a second support bar head, the support bar is connected to the limiting block by the second support bar head, the support bar is connected to the large front bar sheet metal by the first support bar head and the plum nut.

Further, it includes a hinge assembly, two ends of the hinge assembly are connected to the intermediate bar assembly and the plate body respectively. The hinge assembly is provided to support the plate body by using the hinge assembly to enable the car cover to be placed upright. The hinge assembly includes a first hinge, a second hinge and a hinge shaft, one end of the first hinge is provided with a catch, one end of the second hinge is provided with a baffle, the other end of the second hinge is connected to the hinge shaft. The first hinge and the second hinge are both of an arc-shaped structure, the second hinge is connected with an inner baffle on the inside. The end of the first hinge away from the catch is connected to the plate body, the end of the second hinge provided with a baffle is connected to the intermediate bar assembly, the first hinge is located between the inner side plate and the hinge shaft. By providing the inner side plate, the first hinge is limited by using the inner side plate and the hinge shaft, allowing the first hinge to slide along the second hinge.

Further, the plate body is provided with a slider groove, the limiting block is connected to the slider groove, which allows the customer to determine by themselves the position of another fixing point for the support bar. The limiting block may also be provided on the profile, the profile is a structure connected between the intermediate bar assembly and the plate body. It also includes a insertion buckle fixing end fixed to the large front bar, the insertion buckle fixing end is provided with a insertion buckle fixing end spacer, the profile abuts the insertion buckle fixing end spacer to form a fixing point when the car cover is folded up and stood, the intermediate bar assembly and the insertion buckle fixing end, the insertion buckle fixing end spacer and the upper surface of the car cover are all not in contact with each other. The car cover is connected to the car body by a clamp assembly, the car cover is connected with a support bar support member, the clamp assembly is connected to a support bar head fixing block, the first support bar head is connected to the support bar head fixing block, the second support bar head is connected to the support bar support member, the support bar and the rotating shaft structure form two support points to support the upright car cover, the support bar support part can also be connected to the car body or to a guide rail. By providing a insertion buckle fixing end, the upright car cover is supported by the insertion buckle fixing end to ensure the stability of the car cover.

Further, the intermediate bar assembly is connected to the plate body by a profile, the profile is fixed to the plate body by means of glue or rivets. The intermediate bar assembly is connected to the plate body by a hinge assembly, an intermediate spacer bar is provided on the intermediate rotating shaft. The hinge is provided with an angle of rotation greater than 90°, the intermediate rotating shaft assembly is connected by the hinge assembly, the hinge is provided with an angle of rotation greater than 180°.

The beneficial effects of the invention are as follows.

By improving the support structure, the invention ensures the stability of the support when the car cover is standing up by supporting it at two points, making it safer in use.

### DESCRIPTION OF DRAWINGS

FIG. 1 is a structure schematic diagram 1 of the invention.

FIG. 2 is a structure schematic diagram 2 of the invention.

FIG. 3 is a partial enlarged view of the rotating shaft structure of the invention.

FIG. 4 is a structure schematic diagram 1 of Embodiment 2 in the invention.

FIG. 5 is a structure schematic diagram 2 of Embodiment 2 in the invention.

FIG. 6 is a structure schematic diagram 1 of Embodiment 3 in the invention.

FIG. 7 is a structure schematic diagram 2 of Embodiment 3 in the invention.

FIG. 8 is a partial enlarged view of part A in the FIG. 6.

FIG. 9 is a structure schematic diagram 3 of Embodiment 3 in the invention.

FIG. 10 is a partial enlarged view of part B in the FIG. 9.

FIG. 11 is a structure schematic diagram 3 of Embodiment 2 in the invention.

FIG. 12 is a structure schematic diagram 2 of Embodiment 4 in the invention.

FIG. 13 is a partial enlarged view of part D in Embodiment 12.

FIG. 14 is a structure schematic diagram I of the limiting member in the present invention

FIG. 15 is a structural schematic diagram II of the limiting member in the present invention

FIG. 16 is a structure schematic diagram I of the hinge assembly in the present invention

FIG. 17 is a structure schematic diagram of the hinge assembly in the present invention II

FIG. 18 is a sectional view in the C-C direction in FIG. 17.

Figure: 1—First support bar head; 2—Second support bar head; 3—Limiting block; 4—Limiting member; 41—Base; 42—Fixing buckle; 43—Support part; 431—Bayonets; 432—Support groove; 5—Support bar; 6—Slider groove; 7—Large front bar; 8—Rotating shaft structure; 801—Rotating shaft hook; 8011—End; 802—Rotating shaft post; 8021—Stopper; 9—Intermediate spacer; 10—Webbing buckle; 11—Webbing; 12—Webbing base; 13—Plate body; 14—Large front bar sheet metal; 1401—Half waist hole; 15—Hinge assembly; 1501—First hinge; 15011—Catch; 1502—Hinge shaft; 1503—Second hinge; 15031—Baffle; 15032—Inner plate; 16—Plum nut; 17—Intermediate bar assembly; 18—Insertion buckle fixing end; 19—Insertion buckle fixing end spacer; 20—Support bar head fixing block.

### THE CONCRETE METHOD TO CARRY OUT

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media. And it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

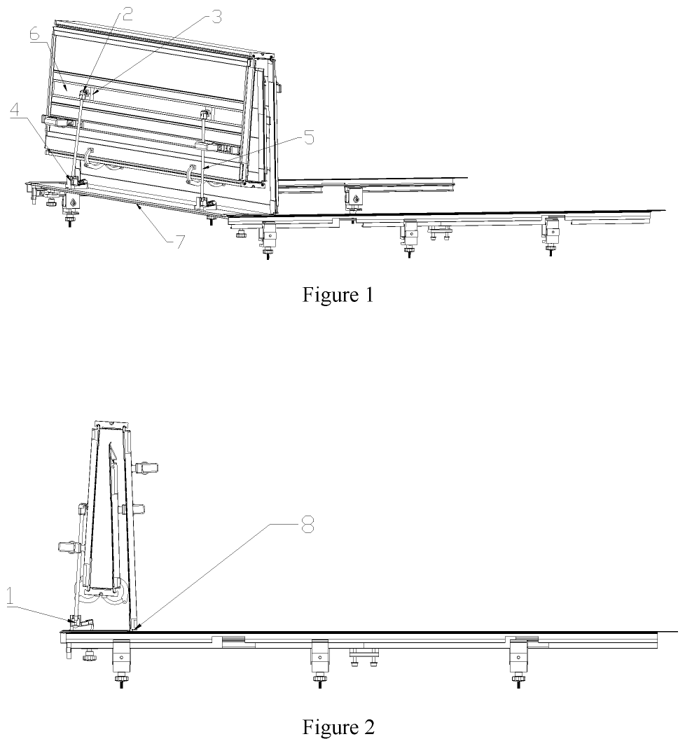

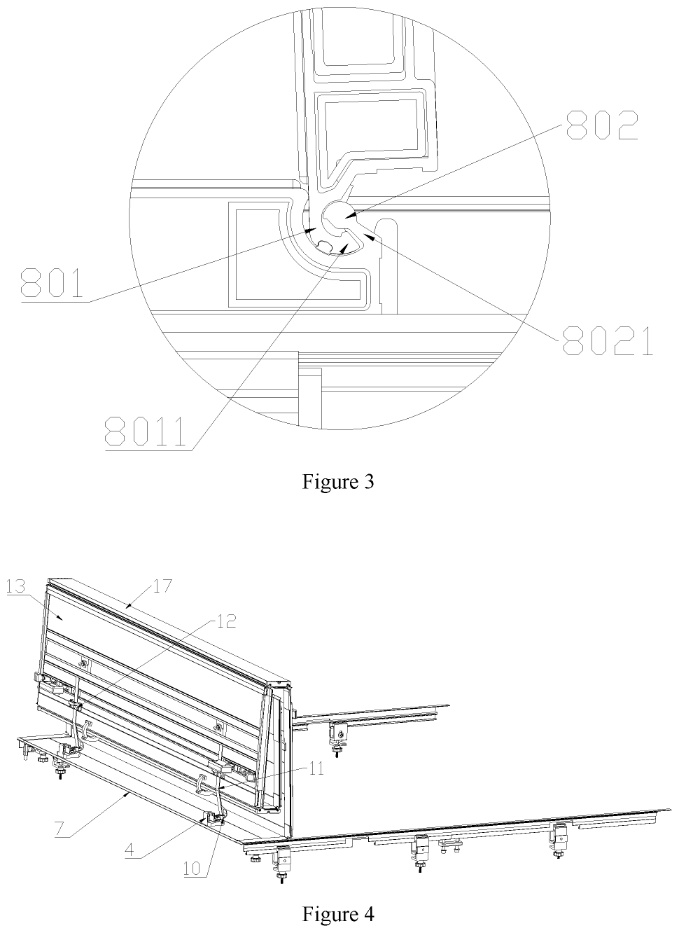

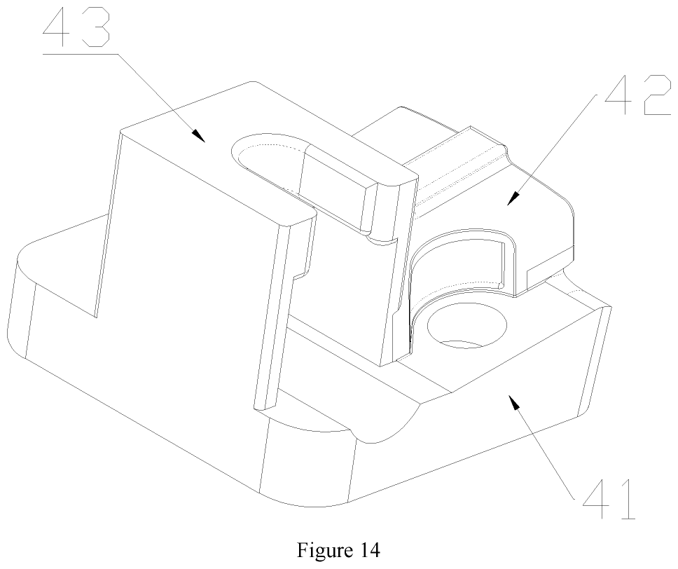

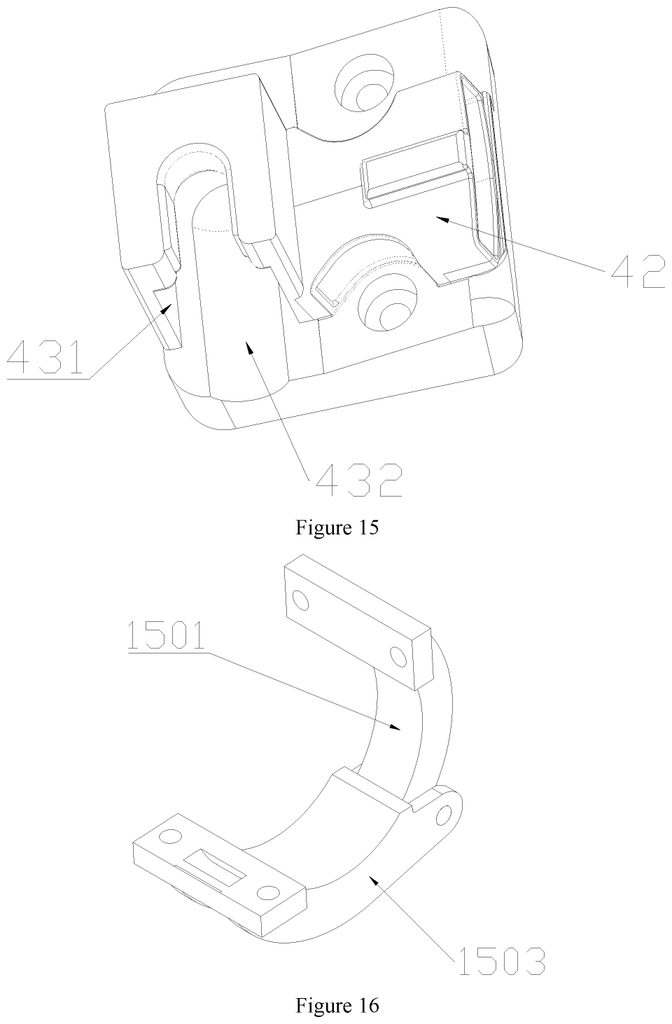

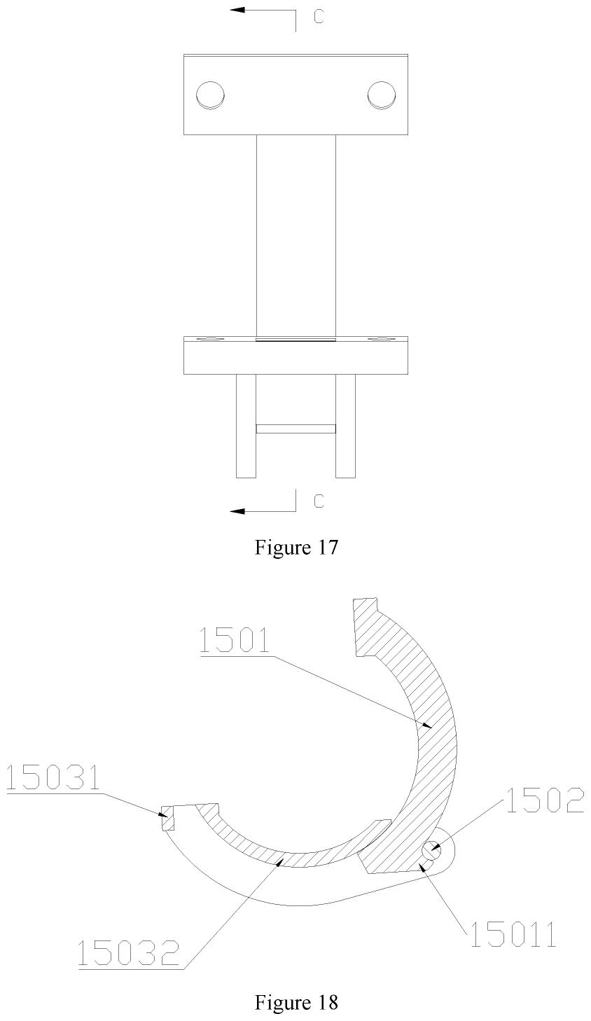

As shown in FIGS. 1-3, 14-18, a new embedded support structure includes a limiting member 4, a support bar 5 and a limiting block 3.

The limiting member 4 is connected to the car body or the car cover.

The limiting block 3 is connected to the car cover.

The support bar 5 includes a first support bar head 1 and a second support bar head 2, the first support bar head 1 is removably connected to the limiting member 4, the second support bar head 2 is connected to the limiting block 3.

By providing the limiting member 4 and the limiting block 3, the support member can be supported, and when the car cover is folded up and standing, it can be connected to the car body by the support member, which can provide stable support for the car cover.

By providing the limiting member 4 and the limiting block 3, the support member can be supported, and when the car cover is folded up and standing, it can be connected to the car body by the support member, which can provide stable support for the car cover.

When the limiting member 4 is connected to the car cover, it is connected to the upper side (front side) of the car cover, the limiting block 3 is connected to the lower side (back side) of the car cover.

The car cover is provided with a slider groove 6 in which the limiting block 3 is located, the second support bar head 2 is rotatably connected to the limiting block 3, the first support bar head 1 is connected to the limiting member 4.

The limiting block 3 is connected to the car cover by screws, by providing the limiting block 3 in the slider groove 6, the limiting block 3 can be slid to a suitable position as required and then the limiting block 3 is connected to the car cover by screws, which can be fixed to any position on the slider groove by customer demand.

By providing a slider groove 6 in the car cover and connecting the limit block 3 to the slider groove 6, the limiting block 3 is able to slide along the slider groove 6 and can be installed in different positions in the slider groove 6 as required.

The limiting member 4 includes a base 41, a fixing buckle 42 and a support part 43, the fixing buckle 42 and the support part 43 are both connected to the base 41, the base 41 is connected to the car body or the car cover; the support part 43 is provided with a bayonet 431 and a support groove 432, the bayonet 431 is provided on the upper side of the support groove 432, the first support rod head 1 is connected to the support groove 432 through the bayonet 431.

The first support bar head 1 is connected to the support portion 43.

The car cover includes a large front bar 7 and a plurality of plate bodies 13, two adjacent plate bodies 13 are connected to each other by an intermediate bar assembly 17, the large front bar 7 and one of the plate bodies 13 are connected by a rotating shaft structure 8, the large front bar 7 is connected to a limiting member 4, the limiting member 4 is at a distance greater than or equal to the width of the intermediate bar assembly 17 from the rotating shaft structure 8. By providing a larger distance between the limiting member 4 and the pivoting structure 8, when the car cover is folded up and standing, it presents a trapezoidal structure with a small top and a large bottom, allowing the car cover to be placed smoothly.

When the car cover is folded up and standing, the rotating shaft structure 8 and the limiting member 4 act as point to support the whole car cover.

By providing the rotating shaft structure 8, when the car cover is folded up and standing, the rotating shaft structure 8 and the support bar 5 work together to support the car cover at two points, with the support bar 5 as one point and the rotating shaft structure 8 as the other point, the two support points are located on either sides of the bottom of the stand up car cover, ensuring the stability.

The rotating shaft structure 8 includes a rotating shaft hook 801 and a rotating shaft post 802, the rotating shaft post 802 is connected to the large front bar 7, the rotating shaft hook 801 is connected to the plate body 13 (alternatively, the rotating shaft post 802 can be connected to the plate body 13, the rotating shaft hook 801 is connected to the large front bar 7, as long as the plate body can be rotated around the rotating shaft structure 8), the rotating shaft hook 801 rotates with the rotating shaft post 802 as its centre;

The rotating shaft hook 801 is provided with an end 8011, the rotating shaft post 802 is provided with a stopper 8021, the stopper 8021 is used to limit the end 8011.

As the plate 13 needs to lift up, the rotation angle of the plate 13 needs to be limited. By interlocking the rotating shaft hook 801 and the rotating shaft post 802, the rotation angle of the plate 13 can be controlled to ensure that the plate 13 can be stably stood up and will not fall down easily.

When in use, the plates 13 are first turned over and folded in turn, then the plates 13 are lifted up together, after that, the rotating shaft structure 8 acts as a support point and then the lower end of the support bar 5 is placed against the limiting member 4 to form another support point for the car cover.

### Embodiment 2

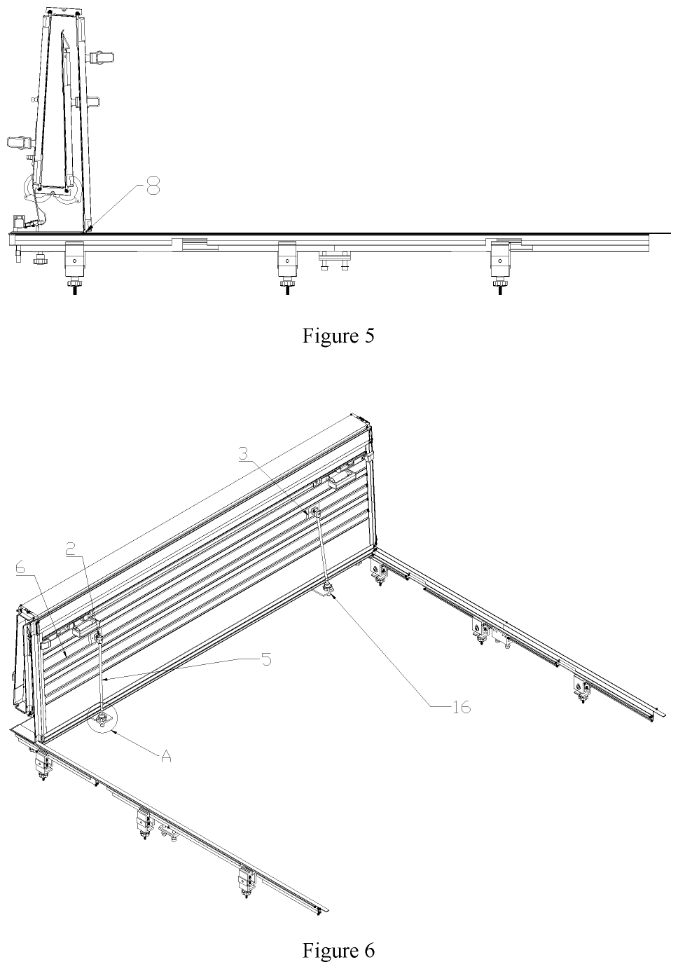

As shown in FIGS. 4, 5, 11, 14-18, a new embedded support structure includes a limiting member 4, a webbing base 12 and a webbing 11;

The limiting member 4 is connected to the car body or the car cover;

The webbing 11 is connected to the car cover by a webbing base 12, the webbing 11 is connected to a webbing buckle 10, the webbing buckle 10 is adapted to the limiting member 4.

The limiting member 4 includes a base 41, a fixing buckle 42 and a support part 43, the fixing buckle 42 and the support part 43 are both connected to the base 41, the base 41 is connected to the car body or the car cover;

The fixing buckle 42 is adapted to the webbing buckle 10.

By inserting the webbing buckle 10 into the fixing buckle 42, the webbing 11 can be tightened to tie the car cover to the large front bar 7 forming a fixing point, and the car cover will be slightly tilted towards the front cab. Furthermore, there is another connection point between the car cover and the car body through the rotating shaft structure 8, which forms a two points of support through the tension of the webbing 11 and the rotating shaft structure 8 to ensure the stability when the car cover is folded and lifting up.

The car cover includes a large front bar 7 and a plurality of plate bodies 13, two adjacent plate bodies 13 are connected to each other by an intermediate bar assembly 17, the large front bar 7 and one of the plate bodies 13 are connected by a rotating shaft structure 8, the large front bar 7 is connected to a limiting member 4, the limiting member 4 is at a distance from the rotating shaft structure 8 greater than or equal to the width of the intermediate bar assembly 17.

The rotating shaft structure 8 includes a rotating shaft hook 801 and a rotating shaft post 802, the rotating shaft post 802 is connected to the large front bar 7, the rotating shaft hook 801 is connected to the plate body 13, the rotating shaft hook 801 rotates with the rotating shaft post 802 as its centre;

The rotating shaft hook 801 is provided with an end 8011, the rotating shaft post 802 is provided with a stopper 8021, the stopper 8021 is provided to limit the end 8011.

As the plate 13 needs to lift up, the rotation angle of the plate 13 needs to be limited. By interlocking the rotating shaft hook 801 and the rotating shaft post 802, the rotation angle of the plate 13 can be controlled to ensure that the plate 13 can be stably stood up and will not fall down easily.

When in use, a plurality of plates 13 are first turned over and folded in turn, then the plates 13 are lifted up together, after that, the rotating shaft structure 8 acts as a point, then the webbing buckle 10 is inserted with the fixed buckle 42 to tie the car cover to prevent the car cover from falling apart.

### Embodiment 3

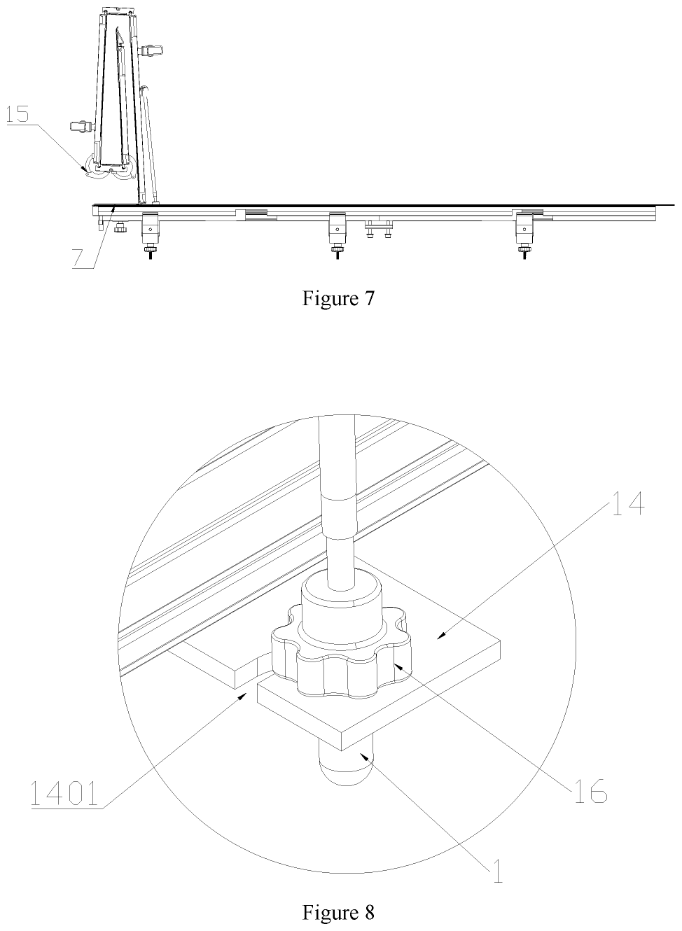

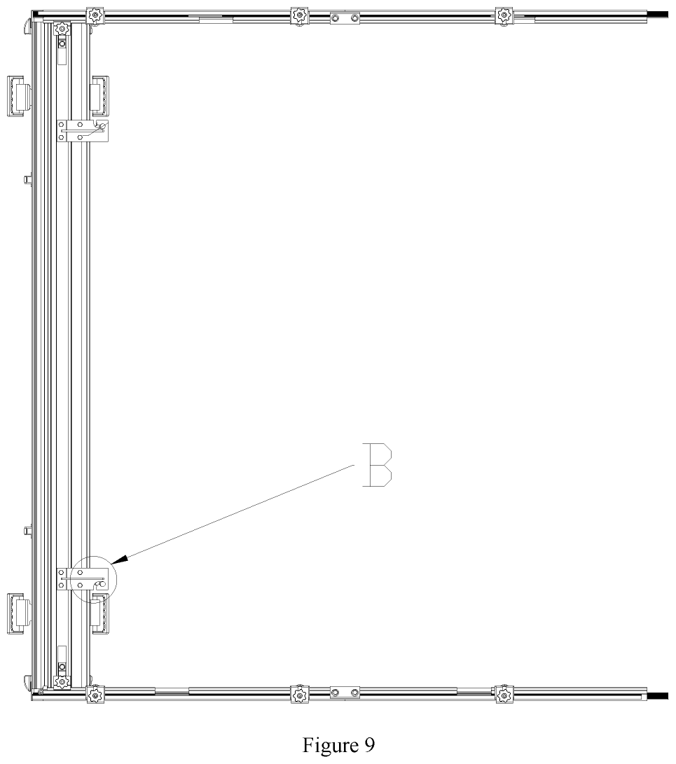

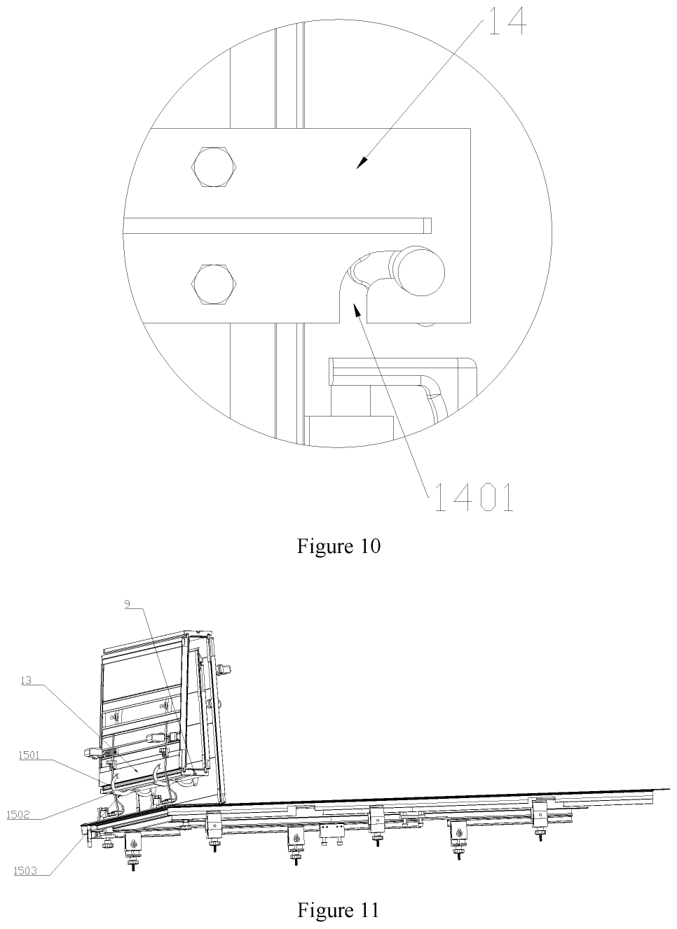

As shown in FIGS. 6-10, 14-18, a new embedded support structure that includes a large front bar sheet metal 14, a support bar 5 and a limiting block 3;

The large front bar sheet metal 14 is connected to the car cover or the car body;

The limiting block 3 is connected to the car cover;

The support bar 5 includes a first support bar head 1 and a second support bar head 2, the first support bar head 1 is connected to the large front bar sheet metal 14. the second support bar head 2 is rotatably connected to the limit block 3.

The large front bar sheet metal 14 is provided with a half-waist hole 1401, the first support bar head 1 is connected with a plum nut 16, the first support bar head 1 passes through the half-waist hole 1401 and the plum nut 16 is connected against the large front bar sheet metal 14.

The car cover is provided with a slider groove 6, the limiting block 3 is provided in the slider groove 6.

The limiting block 3 is provided on the profile.

When in connection, the plum nut 16 is first connected to the first support bar head 1, then the first support bar head 1 passes through the half-waist hole 1401, the plum nut 16 abuts the large front bar sheet metal 14 to form a support for the support bar 5.

The large front bar sheet metal 14 is provided on the back of the car cover, in contrast to the support part 43, which supports the car cover on the other side and prevents the cover from tilting over.

### Embodiment 4

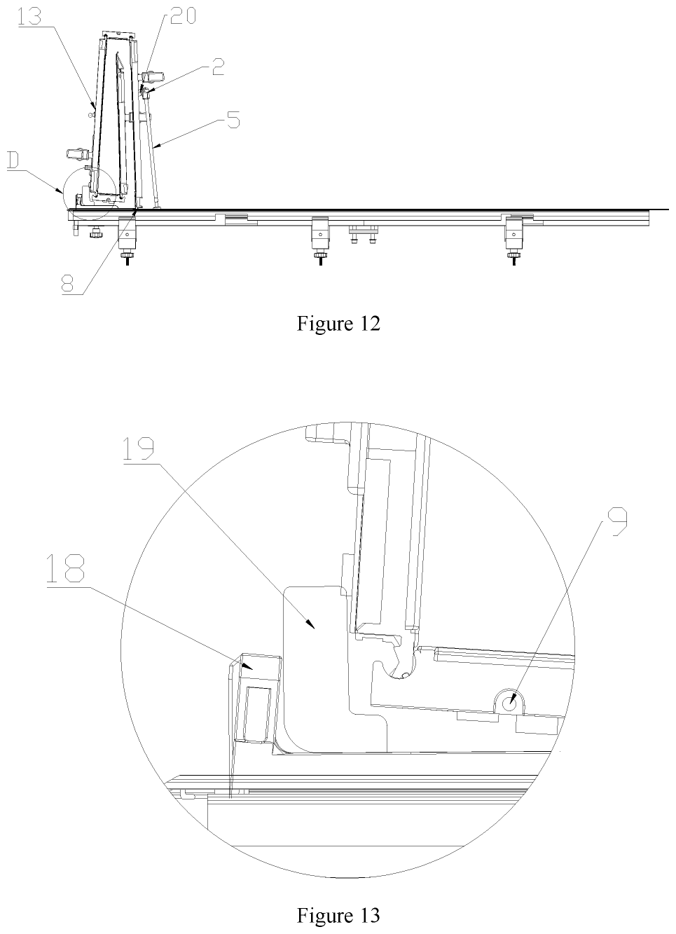

As shown in FIGS. 12-18, a new embedded support structure includes a support bar 5, a limiting member 4, a limiting block 3 and an insertion buckle fixing end 18;

The insertion buckle fixing end 18 is connected to the car cover or car body, the insertion buckle fixing end 18 is provided with an insertion buckle fixing end spacer 19 to form a fixing point, the insertion buckle fixing end spacer 19 is used to support the plate body of the car cover. When the car cover is folded up and standing, the profile rests against the buckle fixing end spacer 19 to form a fixing point, the intermediate bar assembly and the insertion buckle fixing end 18, the insert buckle fixing end spacer 19 and the upper surface of the car cover are all not in contact with each other.

The limiting member 4 is connected to the car body, the limiting block 3 is connected to the car cover, the support bar 5 includes a first support bar head 1 and a second support bar head 2, the first support bar head 1 is removably connected to the limiting member 4, the second support bar head 2 is connected to the limiting block 3.

The limiting block 3 is connected to a guide rail or a side rail.

The car cover is connected to the car body by a clamp assembly, the car cover is connected to a support bar support member, the clamp assembly is connected to a support bar head fixing block (which is similar to limit block 3), the first support bar head 1 is connected to the support bar head fixing block, the second support bar head 2 is connected to the support bar support member. The support bar 5 and the rotating shaft structure 8 form two support points to support the upright car cover, the support bar support member can also be connected to the car body or guide rails.

The car cover includes a large front bar 7 and a plurality of plate bodies 13, two adjacent plate bodies 13 are connected to each other by an intermediate bar assembly 17, the large front bar 7 and one of the plate bodies 13 are connected by a rotating shaft structure 8, the large front bar 7 is connected to a limiting member 4, the limiting member 4 is at a distance from the rotating shaft structure 8 greater than or equal to the width of the intermediate bar assembly 17.

The rotating shaft structure 8 includes a rotating shaft hook 801 and a rotating shaft post 802, the rotating shaft post 802 is connected to the large front bar 7, the rotating shaft hook 801 is connected to the plate body 13, the rotating shaft hook 801 rotates with the rotating shaft post 802 as its centre;

The rotating shaft hook 801 is provided with an end 8011, the rotating shaft post 802 is provided with a stopper 8021, the stopper 8021 is provided to limit the end 8011.

The intermediate bar assembly 17 is connected to the plate body 13 by a profile, the profile is fixed to the plate body 13 by means of glue or rivets.

Further, it includes a hinge assembly 15, both ends of the hinge assembly 15 are connected to the intermediate bar assembly 17 and the plate body 13 respectively;

The hinge assembly 15 includes a first hinge 1501, a second hinge 1503 and a hinge shaft 1502, one end of the first hinge 1501 is provided with a catch 15011, one end of the second hinge 1503 is provided with a baffle 15031 and the other end of the second hinge 1503 is connected to the hinge shaft 1502;

The first hinge 1501 and second hinge 1503 are both of an arc-shaped structure, the second hinge 1503 is provided with an inner baffle inside, the end of the first hinge 1501 away from the catch 15011 is connected to the plate body 13, the end of the second hinge 1503 provided with a baffle 15031 is connected to the intermediate bar assembly 17, the first hinge 1501 is located between the inner side plate 15032 and the hinge shaft 1502.

The intermediate bar assembly 17 is connected to the plate body 13 by a hinge assembly 15, the intermediate bar assembly 17 is provided with an intermediate spacer 9, the hinge assembly 15 is provided with an angle of rotation greater than 90°.

The intermediate bar assembly 17 is connected to the plate body 13 by a hinge assembly 15, the hinge assembly 15 is provided with an angle of rotation greater than 180°.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A new embedded support structure, wherein, it includes: a limiting member (4), a support member (5) and a limiting block (3);
The limiting member (4) is connected to the car body or car cover;
The limiting block (3) is connected to the car cover;
The support bar (5) includes a first support bar head (1) and a second support bar head (2), the first support bar head (1) is removably connected to the limiting member (4), the second support bar head (2) is connected to the limiting block (3).

2. A new embedded support structure according to claim 1, wherein, the car cover is provided with a slider groove (6), the limiting block (3) is provided in the slider groove (6), the second support bar head (2) is connected to the limiting block (3), the first support bar head (1) is connected to the limiting member (4).

3. A new embedded support structure according to claim 2, wherein, the limiting member (4) includes a base (41), a fixing buckle (42) and a support part (43), the fixing buckle (42) and the support part (43) are both connected to the base (41), the base (41) is connected to the car body or the car cover;
The first support bar head (1) is connected to the support part (43).

4. A new embedded support structure according to claim 1, wherein, the car cover includes a large front bar (7) and a plurality of plate bodies (13), two adjacent plate bodies (13) are connected to each other by an intermediate bar assembly (17), the large front bar (7) and one of the plate bodies (13) are connected by a rotating shaft structure (8), the large front bar (7) is connected to the limiting member (4), the limiting member (4) is at a distance greater than or equal to the width of the intermediate bar assembly (17) from the rotating shaft structure (8).

5. A new embedded support structure according to claim 4, wherein, the rotating shaft structure (8) includes a rotating shaft hook (801) and a rotating shaft post (802), the rotating shaft post (802) is connected to the large front bar (7), the rotating shaft hook (801) is connected to the plate body (13), the rotating shaft hook (801) rotates with the rotating shaft post (802) as its centre;
The rotating shaft hook (801) is provided with an end (8011), the rotating shaft post (802) is provided with a stopper (8021), the stopper (8021) is used to limit the end (8011).

6. A new embedded support structure, wherein, it includes a limiting member (4), a webbing base (12) and a webbing (11);
The limiting member (4) is connected to the car body or the car cover;
The webbing (11) is connected to the car cover by a webbing base (12), the webbing (11) is connected with a webbing buckle (10), the webbing buckle (10) is adapted to the limiting member (4).

7. A new embedded support structure according to claim 6, wherein, the limiting member (4) includes a base (41), a fixing buckle (42) and a support part (43), the fixing buckle (42) and the support part (43) are connected to the base (41), the base (41) is connected to the car body or the car cover;
The fixing buckle (42) is adapted to the webbing buckle (10).

8. A new embedded support structure according to claim 7, wherein, the car cover includes a large front bar (7) and a plurality of plate bodies (13), two adjacent plate bodies (13) are connected to each other by an intermediate bar assembly (17), the large front bar (7) and one of the plate bodies (13) are connected by a rotating shaft structure (8), the large front bar (7) is connected to a limiting member (4), the limiting member (4) is connected to the rotating shaft structure (8) is at a distance greater than or equal to the width of the intermediate bar assembly (17) from the rotating shaft structure (8).

9. A new embedded support structure according to claim 8, wherein, the rotating shaft structure (8) includes a rotating shaft hook (801) and a rotating shaft post (802), the rotating shaft post (802) is connected to the large front bar (7), the rotating shaft hook (801) is connected to the plate body (13), the rotating shaft hook (801) rotates with the rotating shaft post (802) as its centre;
The rotating shaft hook (801) is provided with an end (8011), the rotating shaft post (802) is provided with a stopper (8021), the stopper (8021) is used to limit the end (8011).

10. A new embedded support structure, wherein, it include a large front bar sheet metal (14), a support bar (5) and a limiting block (3);
The large front bar sheet metal (14) is connected to the car body or the car cover;
The limiting block (3) is connected to the car cover;
The support bar (5) includes a first support bar head (1) and a second support bar head (2), the first support bar head (1) is connected to the large front bar sheet metal (14), the second support bar head (2) is connected to the limiting block (3).

11. A new embedded support structure according to claim 10, wherein, the large front bar sheet metal (14) is provided with a half-waist hole (1401), the first support bar head (1) is connected with a plum nut (16), the first support bar head (1) passes through the half-waist hole (1401), the plum nut (16) is connected against the large front bar sheet metal (14).

12. A new embedded support structure according to claim 10, wherein, the car cover is provided with a slider groove (6), the limiting block (3) is provided in the slider groove (6).

13. A new embedded support structure according to claim 10, wherein, the limiting block (3) is provided on the profile.

14. A new embedded support structure, wherein, it includes: a support bar (5), a limiting member (4), a limiting block (3) and an insertion buckle fixing end (18);
The insertion buckle fixing end (18) is connected to the car body or the car cover, the insertion buckle fixing end (18) is provided with a insertion buckle fixing end spacer (19);
The limiting member (4) is connected to the car body, the limiting block (3) is connected to the car cover, the support bar (5) includes a first support bar head (1) and a second support bar head (2), the first support bar head (1) is removably connected to the limiting member (4), the second support bar head (2) is connected to the limiting block (3).

15. A new embedded support structure according to claim 14, wherein, the limiting block (3) is connected to a guide rail or a side rail.

16. A new embedded support structure according to claim 14, wherein, the car cover is connected to the car body by a clamp assembly, the car cover is connected to a support bar support member, the clamp assembly is connected to the support bar head fixing block, the first support bar head (1) is connected to the support bar head fixing block, the second support bar head (2) is connected to the support bar support member.

17. A new embedded support structure according to claim 14, wherein, the car cover includes a large front bar (7) and a plurality of plate bodies (13), two adjacent plate bodies (13) are connected to each other by an intermediate bar assembly (17), the large front bar (7) and one of the plate bodies (13) are connected by a rotating shaft structure (8), the large front bar (7) is connected to a limiting member (4), the limiting member (4) is at a distance greater than or equal to the width of the intermediate bar assembly (17) from the rotating shaft structure (8).

18. A new embedded support structure according to claim 17, wherein, the rotating shaft structure (8) includes a rotating shaft hook (801) and a rotating shaft post (802), the rotating shaft post (802) is connected to the large front bar (7), the rotating shaft hook (801) is connected to the plate body (13), the rotating shaft hook (801) rotates with the rotating shaft post post (802) as its centre;
The rotating shaft hook (801) is provided with an end (8011), the rotating shaft post (802) is provided with a stopper (8021), the stopper (8021) is used to limit the end (8011).

19. A new embedded support structure according to claim 17, wherein, the intermediate bar assembly (17) is connected to the plate body (13) by a profile, the profile is fixed to the plate body (13) by means of glue or rivets.

20. A new embedded support structure according to claim 17, wherein, it further includes a hinge assembly (15), two ends of the hinge assembly (15) are connected to the intermediate bar assembly (17) and the plate body (13) respectively;
The hinge assembly (15) includes a first hinge (1501), a second hinge (1503) and a hinge shaft (1502), one end of the first hinge (1501) is provided with a catch (15011), one end of said second hinge (1503) is provided with a baffle (15031), the other end of the second hinge (1503) is connected to the hinge shaft (1502). The first hinge (1501) and the second hinge (1503) are both of an arc-shaped structure, the second hinge (1503) is provided with an inner baffle inside, the end of the first hinge (1501) away from the catch (15011) is connected to the plate body (13), the end of the second hinge (1503) provided with a baffle (15031) is connected to the intermediate bar assembly (17), the first hinge (1501) is located between the inner side plate (15032) and the hinge shaft (1502).

21. A new embedded support structure according to claim 17, wherein, the intermediate bar assembly (17) is connected to the plate body (13) by a hinge assembly (15), the intermediate bar assembly (17) is provided with an intermediate spacer (9), the hinge assembly (15) is provided with an angle of rotation greater than 90°.

22. A new embedded support structure according to claim 17, wherein, the intermediate bar assembly (17) is connected to the plate body (13) by a hinge assembly (15), the hinge assembly (15) is provided with an angle of rotation greater than 180°.

23. A new embedded support structure wherein, it includes: a support bar (5), a limiting member (4), a limiting block (3) and a insertion buckle fixing end (18), a gasket (1101) on the cab;
The insertion buckle fixing end (18) is connected to the car body or the cover, the insertion buckle fixing end (18) is provided with an insertion buckle fixing end spacer (19);
The limiting member (4) is connected to the car body, the limiting block (3) is connected to the car cover, the support bar (5) includes a first support bar head (1) and a second support bar head (2), the first support bar head (1) is removably connected to the limiting member (4), the second support bar head (2) is connected to the limiting block (3).
The car cover can rest on the gasket 1101 of the car cab 11 when supported by the support bar (5).
